(19) United States
(12) Patent Application Publication
(10) Pub. No.: US 2015/0094196 A1
(43) Pub. Date: Apr. 2, 2015

(54) CHAMBER COMPONENT FOR A REAGENT VESSEL, AND USE THEREOF

(71) Applicant: Robert Bosch GmbH, Stuttgart (DE)

(72) Inventors: Martina Daub, Weissach (DE); Guenter Roth, Freiburg (DE); Arne Kloke, Freiburg (DE); Nils Paust, Freiburg (DE); Juergen Steigert, Stuttgart (DE); Felix von Stetten, Freiburg-Tiengen (DE)

(21) Appl. No.: 14/390,780

(22) PCT Filed: Feb. 21, 2013
(86) PCT No.: PCT/EP2013/053474

§ 371 Date: Oct. 4, 2014

(30) Foreign Application Priority Data
Apr. 4, 2012 (DE) 10 2012 205 545.2

(51) Int. Cl. B04B 7/00

(52) U.S. Cl. CPC B04B 7/00
USPC 494/17; 494/16; 494/37

(57) ABSTRACT

A revolver component for a reagent vessel has at least one first chamber that is configured to be filled at least partly with at least one liquid. The first chamber is formed or fitted such that a first chamber filling volume that is configured to be filled with the at least one liquid is delimited by an expansion-variable boundary. The expansion-variable boundary has a spatial expansion that can be reversibly adjusted such that the filling volume is configured to be varied. Reagent vessel insert parts and reagent vessels are also disclosed. Methods for centrifuging a material and for pressure treating a material are also disclosed.

The invention relates to a turret component for a reagent vessel. The invention likewise relates to reagent vessel insert parts and reagent vessels. The invention relates, furthermore, to a method for centrifuging a material and to a method for the pressure treatment of a material.

### PRIOR ART

DE 10 2010 003 223 A1 describes a device for insertion into a rotor of a centrifuge. The device, designed in the format of a standard centrifuge tube, may comprise various turrets which are arranged axially one above the other. The turrets may have ducts, cavities, reaction chambers and further structures for carrying out fluidic unit operations. Via an integrated ballpoint pen mechanism, the turrets can be rotated in relation to one another with respect to their positions, with the result that the structures of the turrets can be connected to one another. After the device has been inserted into a centrifuge, activation of the ballpoint pen mechanism can be triggered by means of a centrifugal force brought about by the operation of the centrifuge. At the same time, liquids can be transferred along the force vector of the centrifugal force caused.

### DISCLOSURE OF THE INVENTION

The invention provides a turret component for a reagent vessel having the features of claim 1, reagent vessel insert parts having the features of claim 10 or 11, reagent vessels for a centrifuge and/or for a pressure variation device having the features of claim 12 or 13, a method for centrifuging a material having the features of claim 14, and a method for the pressure treatment of a material having the features of claim 16.

### Advantages of the Invention

The present invention makes it possible to utilize the first chamber having the variable-expansion boundary in order to implement liquid transport within a reagent vessel. As stated in more detail below, by means of the present invention, in particular, liquid transport can be implemented which is directed counter to an actuator force, such as, for example, a centrifugal force and/or a pressure force. Thus, by means of the present invention, for example, liquid transport can be implemented, even during centrifuging, from a radially outer region within the reagent vessel to a radially inner region within the reagent vessel. Correspondingly, even while underpressure or overpressure is being applied, liquid transport opposite to the applied pressure force vector can be carried out by means of the present invention. The present invention, can be used, in particular, for the pumping and/or mixing of liquids during operation of a centrifuge and/or of a pressure variation device. However, it is pointed out that the applicability of the invention described hereinafter is not limited to the examples of use listed here.

The present invention implements a passive actuation system within a reagent vessel, which can be operated without the use of external active elements. The implementation of the unit operations, such as a mixer, a valve and/or a pump, is in this case possible, without mechanical actuators having to be used/formed for this purpose within the reagent vessel.

The present invention is compatible with the centrifugal processing and/or pressure-driven processing of liquids. Moreover, the present invention can be combined with the use of turrets in a reagent vessel. A turret/turret component may be understood in this context to mean a component which is rotatable/adjustable axially and/or azimuthally within a reagent vessel. For example, at least one turret implementable by means of the present invention can be stacked with other turrets axially one above the other. The implementable turret can have cavities which are designed/fitted for carrying out fluidic unit operations. By means of an elastic mechanism, such as, for example, a ballpoint pen mechanism, the turrets can be positioned both axially and azimuthally with respect to one another. Moreover, the present invention implements reagent vessel insert parts and reagent vessels having at least one such turret/turret component.

In an advantageous embodiment, the variable-expansion boundary comprises an enclosed gas, an elastic filling and/or an elastic diaphragm. The enclosed gas may be, for example, air. The advantageous variable-expansion boundary, which is reversibly compressible and/or reversibly deformable, can thus be implemented cost-effectively.

In a further advantageous embodiment, the turret component may additionally have a second chamber with a filling and/or pressure compensation orifice, said second chamber being connected to the first chamber via at least one first connecting structure having a first hydrodynamic resistance. However, instead of the second chamber of the turret component, the advantageous turret component may also cooperate with a chamber, functioning as a second chamber, of a further turret component/turret. In both instances, a liquid introduced into the second chamber can be sucked into the first chamber by means of an enlargement of the filling volume (of the first chamber). The first chamber having the at least one liquid sucked into it can subsequently be used as a reaction chamber for carrying out a multiplicity of chemical methods and/or biochemical/molecular-biological processes.

In an advantageous development, there is additionally formed on the first chamber a second connecting structure having a second hydrodynamic resistance lower than the first hydrodynamic resistance, via which second connecting structure the first chamber is connected to the second chamber or a third chamber. The revolver component can likewise cooperate with a chamber, functioning as a third chamber, of a further turret component, and, in this case too, the second hydraulic connecting structure, via which the first chamber is connected to the third chamber, may have the second hydrodynamic resistance lower than the first hydrodynamic resistance. The advantageous ratio between the hydrodynamic resistances has the effect that a liquid sucked into the first chamber is pressed out via the second connecting structure in a directed manner wherein the filling volume of the first chamber is reduced. In particular, the ratio between the hydrodynamic resistances may be selected such that a liquid flow out of the first chamber via the first connecting structure is (virtually) prevented. Thus, even without a mechanically adjustable element, a valve device can be implemented by means of the advantageous ratio of the hydrodynamic resistances.

Moreover, the first chamber may be designed to be air-tight, with the exception of the first connecting structure or with the exception of the first connecting structure and the second connecting structure, such that a gas can be enclosed in the first chamber by means of an at least partial filling of the second chamber. This makes it possible to produce the turret component cost-effectively by means of a casting method or an injection molding method.

Preferably, the turret component has a turret outer wall which is designed such that the turret component can be inserted in a reagent vessel for a centrifuge and/or for a pressure variation device. As an alternative or as an addition to this, the turret component may be insertable in an insert part housing of a reagent vessel insert part which is designed such that the reagent vessel insert part can be inserted in a reagent vessel for a centrifuge and/or for a pressure variation device. The turret component can thus advantageously be used, during centrifuging of a material and/or pressure treatment of the material, in order to control/carry out a multiplicity of chemical methods and/or biochemical/molecular-biological processes.

Preferably, the at least one liquid can be sucked into the first chamber, counter to a backforce of the deformed and/or compressed variable-expansion boundary, by means of a centrifugal force capable of being brought about during operation of the centrifuge, in the rotor device of which is arranged the reagent vessel having the turret component inserted therein, and/or by means of a pressure force capable of being brought about during operation of the pressure variation device, in which the reagent vessel having the turret component inserted therein is arranged. Subsequently, the at least one liquid sucked into the first chamber by means of the centrifugal force and/or the pressure force can be pressed out of the first chamber by means of the backforce insofar as the backforce of the deformed and/or compressed variable-expansion boundary is higher than the centrifugal force and/or the pressure force. The pressing out of the at least one liquid previously sucked into the first chamber may in this case take place, in particular, opposite to an orientation of the centrifugal force and/or pressure force. As stated in more detail below, this advantage can be employed for a multiplicity of advantageous possibilities of use.

The advantages described above are also ensured in the case of a reagent vessel insert part with an insert part housing which is designed such that the reagent vessel insert part can be inserted in a reagent vessel for a centrifuge and/or for a pressure variation device, and with at least one turret component according to the present invention which is arranged in the insert part.

Furthermore, said advantages can be implemented by means of a correspondingly designed/equipped reagent vessel insert part.

A reagent vessel for a centrifuge and/or for a pressure variation device, with at least one turret component according to the present invention arranged in the reagent vessel, also affords the advantages described above.

Implementing these advantages is also possible by means of a correspondingly designed/equipped reagent vessel.

Furthermore, the advantages can be brought about by carrying out the method for centrifuging a material and/or the method for the pressure treatment of the material. The advantageous methods may advantageously be used, in particular, for pumping a liquid counter to a centrifugal force/pressure force and/or for mixing a plurality of liquids. However, the possibilities for the use of the methods are not limited to the pumping and mixing methods described in more detail below.

### BRIEF DESCRIPTION OF THE DRAWINGS

Further features and advantages of the present invention are explained below by means of the figures in which:

FIG. 1a to 1e show diagrammatic illustrations of a first embodiment of the turret component;

FIGS. 2a to 2d show diagrammatic illustrations of a second embodiment of the turret component;

FIGS. 3a and 3b show diagrammatic illustrations of a third embodiment of the turret component;

FIGS. 4a and 4b show diagrammatic illustrations of a fourth embodiment of the turret component;

FIGS. 5a and 5b show diagrammatic illustrations of a fifth embodiment of the turret component;

FIGS. 6a and 6b show diagrammatic illustrations of a sixth embodiment of turret components;

FIG. 7 shows a diagrammatic illustration of a seventh embodiment of the turret component;

FIGS. 8a to 8c show diagrammatic illustrations of an eighth embodiment of the turret component;

FIG. 9 shows a diagrammatic illustration of an embodiment of the reagent vessel insert part;

FIG. 10 shows a flowchart for explaining an embodiment of the method for centrifuging a material; and

FIG. 11 shows a flowchart for explaining an embodiment of the method for the pressure treatment of a material.

### EMBODIMENTS OF THE INVENTION

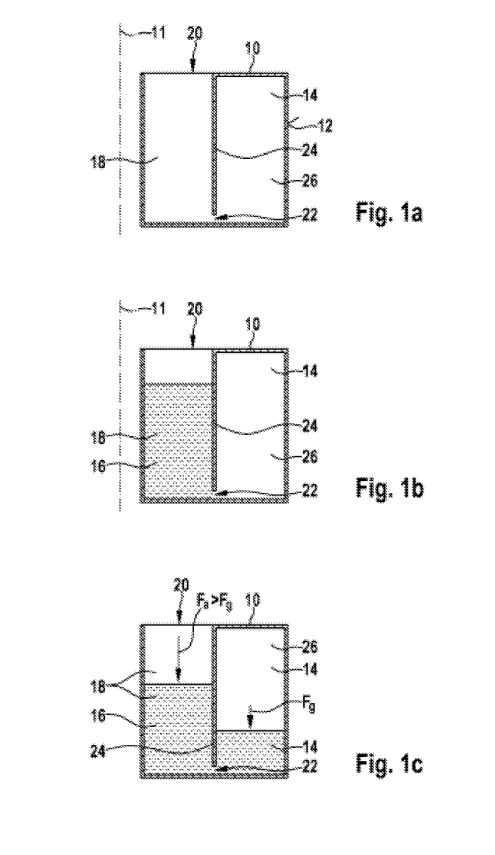

FIG. 1a to 1e show diagrammatic illustrations of a first embodiment of the turret component.

The turret component 10, illustrated (at least partially) diagrammatically in FIG. 1a to 1e, can be used in a reagent vessel. For example, the turret component 10 can have a turret outer wall 12 which is designed such that the turret component 10 can be inserted in a reagent vessel for a centrifuge and/or for a pressure variation device. As an alternative or in addition to this, on account of its turret outer wall 12, the turret component 10 can be inserted in an insert part housing of a reagent vessel insert part which is designed such that the reagent vessel insert part can be inserted in a reagent vessel for a centrifuge and/or for a pressure variation device. The insertability of the turret component 10/of the reagent vessel insert part into the respective reagent vessel for a centrifuge and/or a pressure variation device may be interpreted such that the turret outer wall 12/an outer wall of the insert part housing matches with an inner wall of the reagent vessel. The turret outer wall 12/the outer wall of the insert part housing preferably contacts the inner wall of the reagent vessel in such a way that a reliable hold of the turret component 10/of the reagent vessel insert part in the respective reagent vessel is ensured even while the centrifuge and/or the pressure variation device is in operation.

The reagent vessel may be understood, for example, to mean a (standard) reagent glass/reagent tube. Further exemplary embodiments are centrifuge tubes, 1.5 ml Eppendorf tubes, 2 ml Eppendorf tubes, 5 ml Eppendorf tubes and microtiter plates, such as, for example, 20 μl microtiter plates (per cavity). The reagent vessel may likewise be a test carrier or a disposable cartridge which are formed as a lab-on-a-chip system on a plastic substrate of the size of a plastic card. However, it is pointed out that the implementability of the reagent vessel is not limited to the examples listed here. Moreover, the dimensions of the reagent vessel are stipulated merely in light of a desired ability to insert the reagent vessel in the centrifuge and/or in the pressure variation device. However, the implementability of the technologies according to the invention which are described further on does not stipulate any external shape of the reagent vessel. Furthermore, the reagent vessel may be designed for the reception of samples in an amount which can optionally be selected from a range of a few μl to 1 l.

It is pointed out that the centrifuge and pressure variation device mentioned hereinafter cannot be understood as meaning any specific types of appliance. Instead, the technology according to the invention can be used with any centrifuge, by means of which a (minimum) centrifugal force from 20 g can be exerted. The technology according to the invention may likewise be used for any pressure variation device, by means of which an underpressure and/or overpressure can be applied.

The turret component 10 may be understood, in particular, to mean a turret for a reagent vessel. The turret component 10 may be designed, for example, in such a way that it is rotatable about an axis of rotation 11 by means of a suitable mechanism which may be arranged on the turret component 10 or separately from the turret component 10. The axis of rotation 11 may, in particular, run centrally through the turret component 10. In particular, the turret component 10/reagent vessel insert part may also be designed to cooperate with a ballpoint pen mechanism or may comprise a ballpoint pen mechanism. The turret component 10/reagent vessel insert part may have a capacity by volume lower than 5 milliliter. The turret component 10 may be designed, in particular, such that it can be integrated in a stack of further turrets and/or reaction chambers. By means of a ballpoint pen mechanism, turrets, reaction chambers and/or cavities (stacked axially one above the other) can be positioned both axially and azimuthally with respect to one another. As regards one possible version of the ballpoint pen mechanism, reference is made to DE 2010 003 223 A1.

On the turret component 10, at least one first chamber 14 is formed which is at least partially fillable/filled with at least one liquid 16. Moreover, the turret component 10 may additionally have a second chamber 18 with a filling and/or pressure compensation orifice 20, said second chamber being connected to the first chamber 14 via at least one first connecting structure 22 (having a first hydrodynamic resistance). The first connecting structure 22 may be designed, for example, as an orifice in a partition 24 between the chambers 14 and 18 or as a duct structure. It is pointed out that the implementability of the first connecting structure 22 can be selected with a wide freedom of design.

The turret component 10 described hereinafter is not limited to being equipped with the second chamber 18. Instead, forming the second chamber 18 on the turret component 10 with the first chamber 14 is to be interpreted merely by way of example. As an alternative to this, the turret component 10 may also cooperate with a chamber, functioning as a second chamber 18, of a further turret component (not illustrated). The turret component 10 may correspondingly also cooperate with a chamber, functioning as a second chamber 18, of a reagent vessel insert part and/or of a reagent vessel, which chamber is formed at a fixed location with respect to the insert part housing of the reagent vessel insert part or with respect to the outer wall of the reagent vessel.

The first chamber 14 is designed or fitted such that a filling volume, fillable or filled with the at least one liquid 16, of the first chamber can be delimited by means of a variable-expansion boundary. The variable-expansion boundary has reversibly variable spatial expansion such that the filling volume can be varied (in size). The first chamber 14 may comprise, for example, an enclosed gas 26, an elastic filling and/or an elastic diaphragm as the variable-expansion boundary.

In the embodiment of FIG. 1a to 1e, the first chamber 14 is designed such that it is closed off, with the exception of the first connecting structure 22, so as to be air-tight and liquid-tight with respect to its external surroundings. A gas 26, such as, in particular, air, present in the first chamber 14 can therefore escape from the first chamber 14 through the first connecting structure 22 only.

FIG. 1a shows the turret component 10 before the at least one liquid 16 is introduced through the filling and/or pressure compensation orifice 20 of the second chamber 18. After the introduction of the at least one liquid 16, the gas 26 remains enclosed in the first chamber 14 (see FIG. 1b). (The first connecting structure 22 has such a small (maximum) width that an escape of the gas 26 from the first chamber 14 while the at least one liquid is at the same time trickling into the first chamber 14 is prevented). On account of the air-tight and liquid-tight design of the first chamber 14 which merely has the first connecting structure 22 for the escape of the gas 26 introduced therein, a filling volume, fillable/filled with the at least one liquid 16, of the first chamber 14 is delimited by means of the enclosed gas 26 as the variable-expansion boundary. The variable-expansion boundary implementable by the enclosed gas 26 has reversibly variable spatial expansion such that the filling volume can be varied (in size).

After the turret component 10, having the at least one liquid 16 introduced into the second chamber 18, has been arranged in a centrifuge and/or a pressure variation device, an actuation force Fa can be exerted upon the at least one liquid 16 by operating the centrifuge/pressure variation device. Preferably, the turret component 10 can be arranged in the centrifuge/pressure variation device such that the first connecting structure 22 connects a subregion, oriented in the direction of the actuation force Fa, of the first chamber 14 to a subregion, oriented in the direction of the actuation force Fa, of the second chamber 18. The advantage described hereinafter is also ensured insofar as the turret component 10 can be arranged in the centrifuge/pressure variation device such that the first chamber 14 is oriented in the direction of the actuation force Fa with respect to the second chamber 18. (The orientation of a chamber subregion/of a chamber in the direction of the actuation force Fa may be understood to mean that the chamber subregion/chamber lies, with respect to a remaining chamber region/another chamber, in the direction of the tip of a vector reproducing the actuation force Fa). On account of the advantageous arrangement/orientation of the turret component in the centrifuge/pressure variation device, in this case, for example even at a rotational acceleration of between 20 g and 1000 g, the actuation force Fa causes the at least one liquid 16 to be pressed out of the second chamber 18 at least partially into the first chamber 14. This action can be paraphrased by saying that the at least one liquid 16 is capable of being sucked into the first chamber 14, counter to a backforce Fg of the compressed gas 26 serving as the variable-expansion boundary, by means of a centrifugal force capable of being brought about during operation of the centrifuge, in the rotor device of which is arranged the reagent vessel having the turret component 10 inserted therein, and/or by means of a pressure force capable of being brought about during the operation of the pressure variation device, in which the reagent vessel having the turret component 10 inserted therein is arranged (see FIG. 1c). Consequently, by means of the actuation force Fa, the at least one liquid 16 can be pressed at least partially into the first chamber 14 such that the gas 26 serving as the variable-expansion boundary is compressed, with the result that the backforce Fg builds up. The gas 26 serving as the variable-expansion boundary is compressed as a result of the (at least partial) pressing of the at least one liquid 16 into the first chamber 14, until the resultant backforce Fg is equal to the actuation force Fa exerted (upon the at least one liquid 16). This is illustrated in FIG. 1d. In the event of an equilibrium of the two forces Fa and Fg, neither compression of the gas 26 serving as the variable-expansion boundary nor a liquid flow through the first connecting structure 22 takes place.

When the actuation force Fa is subsequently reduced, the dominant backforce Fg causes expansion of the previously compressed gas 26, with the result that the filling volume of the first chamber 14 is reduced and the liquid quantity, sucked/pressed into the first chamber 14, of the at least one liquid 16 is pressed/displaced out of the first chamber 14 (see FIG. 1e). This causes a liquid flow from the first chamber 14 through the first connecting structure 22 into the second chamber 18, which liquid flow persists until there is once again an equilibrium of the forces Fa and Fg.

The actions described with reference to FIG. 1c to 1e may be repeated periodically. The gas enclosed in the first chamber 14 thus acts as an elastic element/as a pneumatic actuation unit. As a result of the compression and subsequent expansion of the enclosed gas 26, the at least one liquid 16 can be transported in a desired direction which can be set by means of the exerted/applied actuation force Fa. It is pointed out that the at least one liquid 16 can, in particular, also be prompted into a liquid flow, which is directed opposite to the gravitational field and/or the actuation force Fa, by means of the procedure described here.

The gas 26 used as an advantageous variable-expansion boundary may occupy a volume lower than 5 ml. The gas 26 may, in particular, perform its advantageous function directly in contact with the at least one liquid 16. In a development, however, the gas 26 may also be delimited from the at least one liquid 16 by means of a separation component, such as, for example, a flexible diaphragm. To generate the gas 26 enclosed in the first chamber 14, special capture structures (similar to a diving bell) may also be formed on the turret component 10.

The gas 26 used may be, in particular, air. Instead of air, however, nitrogen, oxygen and/or a noble gas, such as, for example, argon, may also be employed as the gas 26. It is pointed out that, instead of the gas 26, an elastic filling, such as, for example, a polymer filling, can also be used.

The at least one liquid 16 may be, for example, water, blood, saliva, urine, at least one buffer solution, a cell suspension, a solution enriched with proteins and/or DNA strands (RNA strands) and/or a solution with tissue samples. It is pointed out that the insertability of the turret component 10 described in the above paragraphs can be utilized for a multiplicity of solutions 16.

As becomes clear from FIG. 1a, the turret component 10 may have its advantageous insertability even before being filled with the at least one liquid 16. The advantageous turret component 10 is thus not limited to turret components 10 which are fitted with the variable-expansion boundary. Instead, the turret component 10 may also be designed in such a way that the advantageous variable-expansion boundary is present in the first chamber 14 at least after the at least one liquid 16 has been introduced. This is the case, in particular, insofar as the first chamber 14 is designed to be air-tight, with the exception of the first connecting structure 22 or with the exception of the first connecting structure 22 and a second connecting structure (described in more detail below), such that a gas 26/air can be enclosed in the first chamber 14 by means of an at least partial filling of the second chamber 18. Moreover, a selected (maximum) width of the first connecting structure 22 and/or of the second connecting structure may be so small that a simultaneous escape of gas 26/air and penetration of at least one liquid through the first/second connecting structure are prevented.

The advantageous turret component 10 can therefore be produced even without being fitted with a variable-expansion boundary shaped/formed from specific material. For example, the turret component 10 may be produced in one piece by means of a casting method or an injection molding method. The turret component 10 can thus be produced cost-effectively. The inner volume of the turret component 10/of the reagent vessel insert part equipped with it may be made at least partially from a polymer, for example from COP, COC, PC, PA, PU, PP, PET and/or PMMA. Further materials are also suitable for forming the inner volume of the turret component 10/of the reagent vessel insert part equipped with it. The turret component 10/the reagent vessel insert part equipped with it can also be produced cost-effectively from only a single material.

At least one duct, at least one cavity and/or at least one reaction chamber may additionally be formed in the turret component 10/a reagent vessel insert part equipped with it. In the inner volume of the turret component 10/of the reagent vessel insert part, process steps and structures, such as, for example, sedimentation structures, duct structures or siphon structures for the transfer and switching of at least one liquid 16 contained in the turret component 10/the reagent vessel insert part, may be integrated. In particular, at least one further subunit of the inner volume of the turret component 10/of the reagent vessel insert part may be filled as a “reservoir” with at least one liquid 16 which carries out at least one chemical reaction and/or biochemical/molecular-biological process with a subsequently introduced material/sample material to be processed and/or to be investigated. The at least one “reservoir” may be filled, for example, with chemicals (for example, buffers), enzymes, lyphilisates, beads, dyes, antibodies, antigens, receptors, proteins, DNA strands and/or RNA strands. The turret component 10/reagent vessel insert part may also be equipped with additional components, such as, for example, valves and/or pumps. Moreover, the technology according to the invention may also interact with a multiplicity of conventional actuation, detection and/or control units.

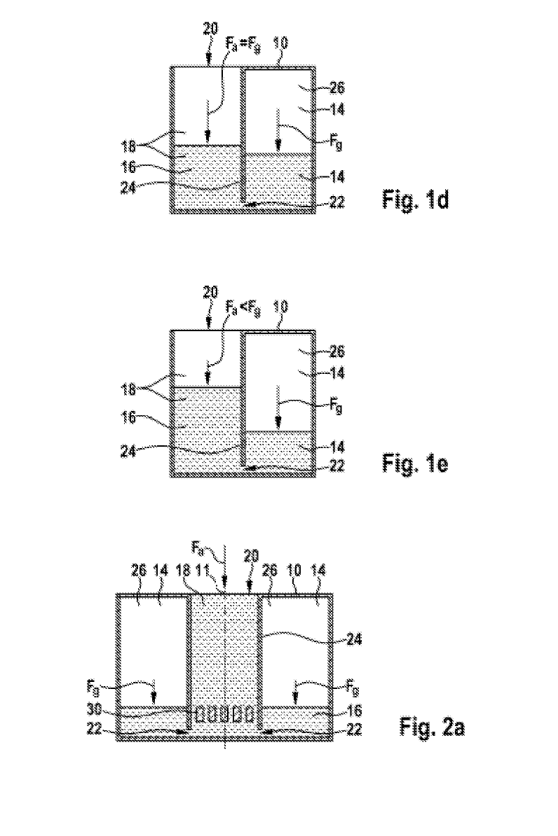

FIGS. 2a to 2d show diagrammatic illustrations of a second embodiment of the turret component.

The turret component 10 illustrated (at least partially) diagrammatically in FIGS. 2a to 2d has a double design of the first chamber 14 which can be used in each case as a capture structure for enclosing the gas 26 (with a defined gas volume). Moreover, an obstacle structure 30 is formed preferably in the second chamber 18. The obstacle structure 30 may be mounted at a fixed location in the turret component 10 or be designed to be movable. The obstacle structure 30 may be, for example, a sieve.

The at least partial filling of the second chamber 18 with the at least one liquid 16 causes the gas 26 to be enclosed in the two first chambers 14 (see FIG. 2a). By means of an actuation force Fa (higher than the backforce Fg), the enclosed gas 26 can be compressed, with the result that a first liquid stream 32a out of the second chamber 18 in each case via a first connecting structure 22 into the assigned first chamber 14 can be triggered (see FIG. 2b). As can be seen from FIG. 2c, the compression of the gas 26 is stopped in the event of an equilibrium of the forces Fa and Fg. When the actuation force Fa is reduced (to below the backforce Fg), a second liquid stream 32b passes out of each first chamber 14 in each case via a first connecting structure 22 into the second chamber 18 (see FIG. 2d).

The embodiment illustrated in FIGS. 2a to 2d may, by a periodic variation of the actuation force Fa triggering a periodic compression and expansion of the gas 26, be utilized to mix at least two liquids 16 by means of the liquid streams 32a and 32b brought about. The mixing efficiency can advantageously be increased by means of the at least one obstacle structure 30.

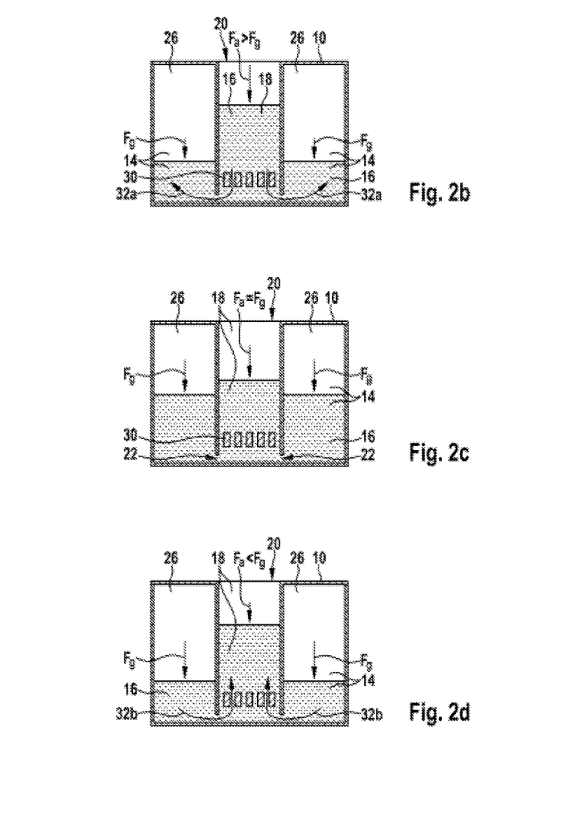

FIGS. 3a and 3b show diagrammatic illustrations of a third embodiment of the turret component.

In the turret component 10 illustrated (at least partially) diagrammatically in FIGS. 3a and 3b, there is additionally formed on the first chamber 14 a second connecting structure 36 having a second hydrodynamic resistance, via which second connecting structure the first chamber 14 is connected to the second chamber 18. (As stated in more detail below, the first chamber 14 may also be connected to a third chamber via the second connecting structure 36). The second connecting structure 36 may be designed as a connecting orifice/connecting bore in a vessel wall or as a duct structure. The first chamber 14 may nonetheless be designed such that, with the exception of the connecting structures 22 and 36, it is designed to be air-tight with respect to its external surroundings.

Preferably, the second hydrodynamic resistance of the second connecting structure 36 is lower than the first hydrodynamic resistance of the first connecting structure 22. Moreover, an orifice, oriented toward the second chamber 18, of the first connecting structure 22 may be made on a first side, lying in the direction of the actuation force Fa, of the second chamber 18, while an orifice, oriented toward the second chamber 18, of the second connecting structure 36 is arranged on a second side, lying opposite the first side, of the second chamber 18. (The orientation of the first side in the direction of the actuation force Fa may be understood to mean that the first side lies, with respect to a mid-point/mid-region of the second chamber, in the direction of the tip of a vector reproducing the actuation force Fa. The vector of the actuation force Fa can thus be oriented from the second side to the first side of the second chamber 18).

As can be seen from FIG. 3a, in this case an actuation force Fa (centrifugal force and/or pressure force), which is higher than the backforce Fg, causes a liquid flow 32a out of the second chamber 18 through the first connecting structure 22 into the first chamber 14, with the result that the gas 26 is compressed. (The liquid flow 32a is not impaired by the obstacle structure 30 mounted in the second chamber 18). The liquid flow 32a through the first connecting structure 22 is stopped in the event of an equilibrium of the forces Fa and Fg.

By a subsequent reduction of the actuation force Fa (centrifugal force and/or pressure force), the at least one liquid 16 sucked into the first chamber 14 by means of the actuation force Fa can be pressed out of the first chamber 14 again (see FIG. 3b). Insofar as the backforce Fg of the compressed gas 26 used as a variable-expansion boundary is higher than the actuation force Fa, the at least one liquid 14 previously sucked into the first chamber 14 is pressed out of the first chamber 14 by means of the backforce Fg. If a second hydrodynamic resistance of the second connecting structure 36 is lower than the first hydrodynamic resistance of the first connecting structure 22, the backforce Fg causes, in particular, a liquid stream 38 which is directed from the first chamber 14 through the second connecting structure 36 into the second chamber 18.

By the at least one liquid 16 being extracted on the first side of the second chamber 18 and by the at least one liquid 16 being reintroduced into the second chamber 18 on the second side, the at least one liquid 16 can be mixed thoroughly and comparatively quickly. The embodiment of FIGS. 3a and 3b can thus advantageously be employed as a mixing device.

The advantageous ratio between the first hydrodynamic resistance of the first connecting structure 22 and the second hydrodynamic resistance of the second connecting structure 36 can be fixed reliably by a suitable choice of the lengths and/or widths/cross-sectional areas of the connecting structures 22 and 36. Preferably, a length and/or width of the first connecting structure 22 are/is smaller than a length and/or width of the second connecting structure 36. For example, the first connecting structure 22 may be a narrow and short gap/duct with a length of between 100 μm and 1 cm and/or with a first width of between 10 μm and 2 mm, while the second connecting structure 36 has a length of between 1 mm and 5 cm and/or a width of between 1 mm and 1 cm. This ensures that the liquid quantity previously sucked into the first chamber 14 via the first connecting structure 22 is pressed out of the first chamber 14 almost exclusively via the second connecting structure 36.

In a development, the second connecting structure 36 leading on from the first chamber 14 may also open into a third chamber (not shown). The periodic variation, described in FIGS. 3a and 3b, of the actuation force Fa can thus also be utilized for pumping the at least one liquid 16 out of the second chamber 18 into the third chamber. The enclosed gas 26/gas volume can thus be employed as a compression pump. It is pointed out expressly that this pumping action can also be carried out insofar as the third chamber lies on a (second) side, directed opposite to the orientation of the actuation force Fa, of the second chamber 18. This advantage may also be paraphrased by saying that the at least one liquid 16 can be pumped opposite to the actuation force Fa by means of the procedure described here. Even an actuation force Fa which occurs at a rotational acceleration of at least 1000 g can still be overcome in this way. Radially inward-directed liquid transport can thus still be brought about, even during centrifuging, by periodically raising and lowering the centrifugal force.

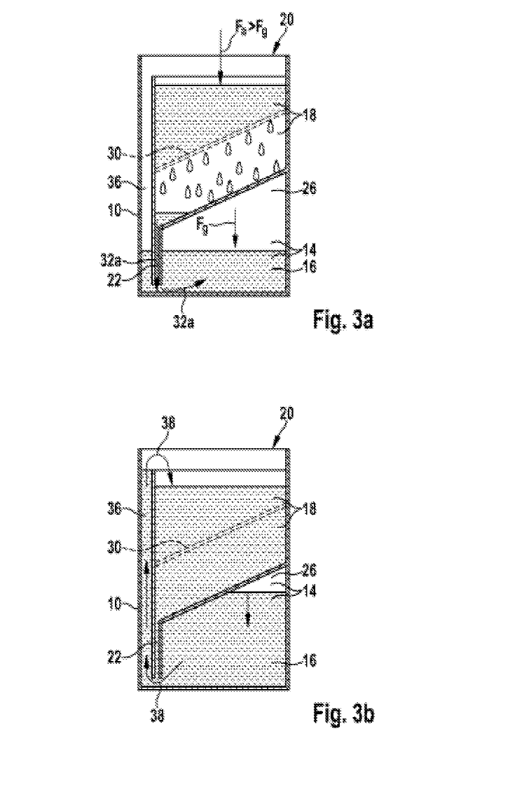

FIGS. 4a and 4b show diagrammatic illustrations of a fourth embodiment of the turret component.

The turret component 10 illustrated (at least partially) diagrammatically in FIGS. 4a and 4b has, as an addition to the embodiment described above, a valve and/or closing device of the first connecting structure 22. The valve and/or closing device comprises a magnet 40, arranged in or on the first connecting structure 22, and at least one actuating element 42 which is formed at least partially from a magnetically attractable material. Insofar as no actuation force Fa which is higher than the force of attraction of the magnet 40 acts upon the at least one actuating element 42, the at least one actuating element 42 is held by the magnet 40 in an initial position in which the first connecting structure 22 is sealed off, liquid-tight, by the at least one actuating element 42. The liquid stream 32a through the first connecting structure 22 is thus ensured only after the at least one actuating element 42 is adjusted out of its initial position into at least one end position by means of the actuation force Fa (higher than the force of the attraction of the magnet 40) (see FIG. 4a). Consequently, while the at least one liquid 16 is being sucked into the first chamber 14 by means of a suitable highly selected actuation force Fa, the first connecting structure 22 can be controlled into an open state, with the result that the desired liquid flow 32a through the first connecting structure 22 is ensured.

A subsequent decrease in the actuation force Fa causes the at least one actuating element 42 to be attracted by means of the (higher) force of attraction of the magnet 40, with the result that the first connecting structure 22 is controlled into a closed/sealed-off state again. Thus, when the previously sucked-in liquid quantity is subsequently pressed out of the first chamber 14, it can be ensured that the liquid quantity pressed out flows solely as a liquid stream 38 through the second connecting structure 36, whereas a trickle of liquid through the first connecting structure 22 can be reliably prevented (see FIG. 4b).

As an alternative to the embodiment of FIGS. 4a and 4b, the valve or closing mechanism may also be implemented by means of a spring/mass system. However, there is no need here for a detailed description of such a spring/mass system, in which at least one mass can be held in a connecting structure 22 or 36 by means of the spring, such that the at least one mass can be pressed out of the connecting structure 22 or 36 by means of the actuation force Fa, while a decrease in the actuation force Fa leads to a predominance of the spring force and to a back-adjustment of the at least one mass.

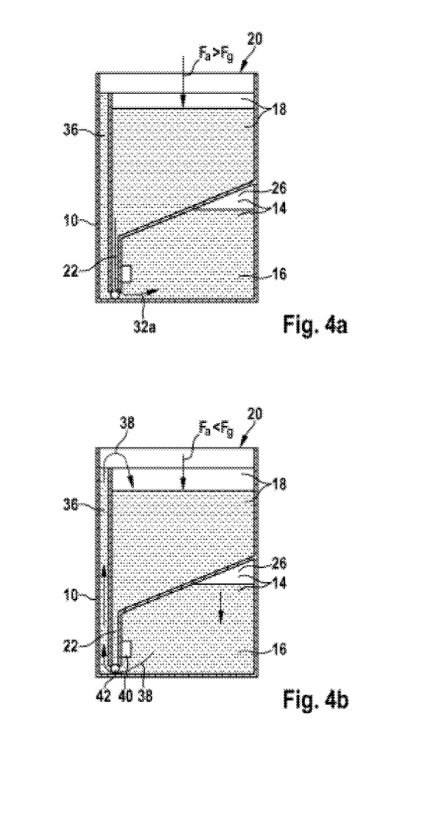

FIGS. 5a and 5b show diagrammatic illustrations of a fifth embodiment of the turret component.

The turret component 10 illustrated (at least partially) diagrammatically in FIGS. 5a and 5b has an elastic cover 44, such as, for example, an elastomeric diaphragm, which is tension-mounted adjacently to an inlet and/or outlet orifice of the first connecting structure 22. Insofar as the elastic cover 44 experiences no external force, the elastic cover 44 covers (liquid-tight) the inlet and/or outlet orifice of the first connecting structure 22.

By means of a sufficiently high actuation force Fa, the elastic cover 44 can be deformed counter to its tension force Fs, such that the inlet and/or outlet orifice of the first connecting structure 22 is at least partially exposed, thereby making the liquid flow 32a through the first connecting structure 22 possible.

A decrease in the actuation force Fa leads to a predominance of the tension force Fs, with the result that the previously exposed inlet and/or outlet orifice of the first connecting structure 22 can be closed again by means of the elastic cover 44. In this case, too, after the inlet and/or outlet orifice of the first connecting structure 22 has been covered by means of the elastic cover 44, it is reliably ensured that the liquid quantity pressed out of the first chamber 14 is conducted solely as a liquid stream 38 through the second connecting structure 36, whereas a liquid flow through the first connecting structure 22 is reliably prevented.

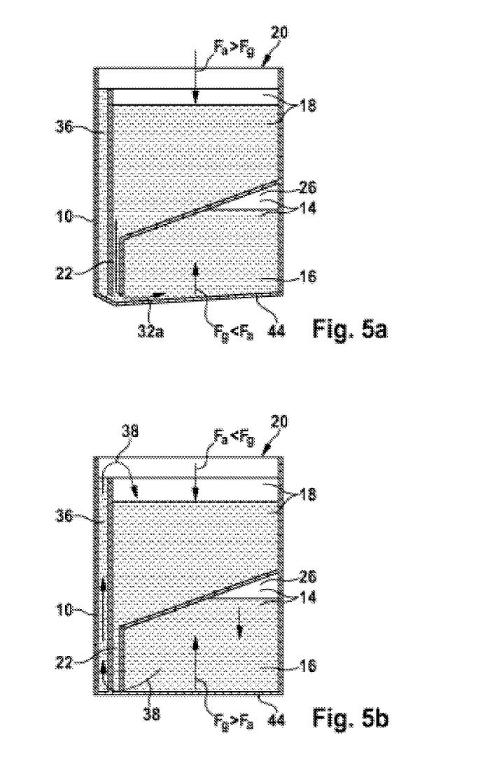

FIGS. 6a and 6b show diagrammatic illustrations of a sixth embodiment of turret components.

The turret components 10a and 10b illustrated (at least partially) diagrammatically in FIGS. 6a and 6b may be arranged, for example, in a reagent vessel insert part/reagent vessel (not shown). The turret components 10a and 10b are connected to one another by means of a mechanism (not illustrated), such as, for example, a ballpoint pen mechanism, such that the first turret component 10a can be rotated at a defined angle α (illustrated as a travel) about an axis of rotation with respect to the second turret component 10b. By means of the rotation 46 through the angle α, a projecting portion 48, for example a plinth or a plunger, formed on the second turret component 10b can be pressed against the elastic cover 44 such that the elastic cover 44 covers, liquid-tight, the first connecting structure 22. The closing of the first connecting structure 22 can thus also be carried out by means of a relative movement of the two turret components 10a and 10b.

A further possibility for forming a valve and/or closing device is a movable closure similar to a nonreturn valve. During outflow, the movable closure, which is designed, for example, as a bar, plate or lid, is pressed open, and, during the backflow, the movable closure is actively pressed shut by the liquid flowing back. Pressing shut is actively assisted by a return force of suspension of the movable closure. A further possible embodiment of the valve and/or closing device may be based on a float which utilizes a difference in density between the chambers 14 and 18.

Pumping efficiency can be effectively increased by the design of one of the valve and/or closing devices described above.

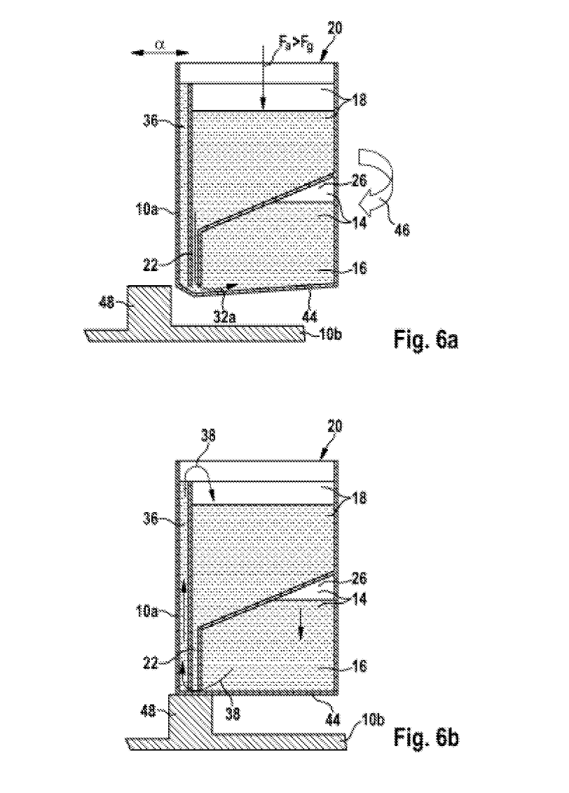

FIG. 7 shows a diagrammatic illustration of a seventh embodiment of the turret component.

The turret component 10 illustrated (at least partially) diagrammatically in FIG. 7 comprises a plurality of pumping structures 14a, 14b and 14c used as the first chamber 14a, 14b and 14c and a plurality of storage structures 18a, 18b and 18c used as the second chamber 18a, 18b and 18c, each of the first chambers/pumping structures 14a, 14b and 14c being connected via their connecting structures 22a, 22b, 22c, 36a, 36b and/or 36c to two different second chambers/storage structures 18a, 18b and 18c. In the turret component 10, a plurality of pumping structures 14a, 14b and 14c are thus connected to one another in such a way that a pumping cascade is implemented within the turret component 10. By the gases 26 in the pumping structures 14a, 14b and 14c being compressed and expanded, the at least one liquid 16 can be transferred into at least one following storage structure 18b and 18c. As an addition, at least one storage structure 18a, 18b and 18c may also be equipped with an obstacle structure, such as, for example, a sieve.

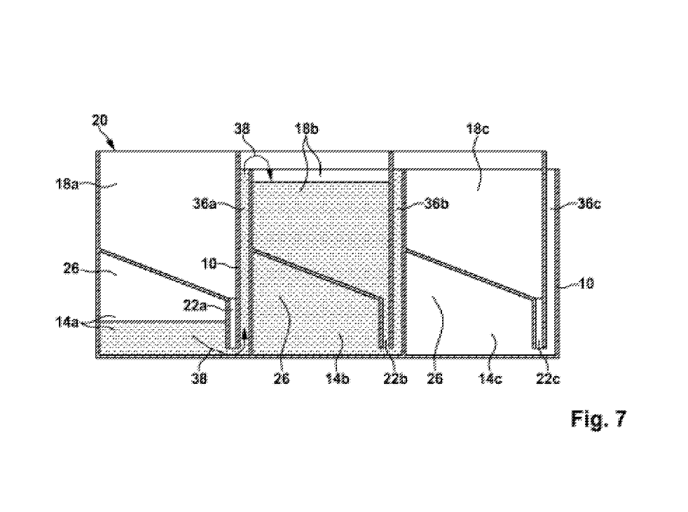

FIGS. 8a to 8c show diagrammatic illustrations of an eighth embodiment of the turret component.

The turret component 10 illustrated (at least partially) diagrammatically in FIGS. 8a to 8c has an elastic diaphragm 50 as a variable-expansion boundary. The elastic diaphragm 50 is arranged in the first chamber 14 in such a way that the elastic diaphragm can be arched in a direction opposite to the first connecting structure 22 by the at least one liquid 16 being introduced/pressed into the filling volume of the first chamber 14 (by means of the actuation force Fa), with the result that the filling volume of the first chamber 40 can be enlarged. For example, the elastic diaphragm is tension-mounted at its margins on the walls of the first chamber 14 such that it delimits (liquid-tight) the filling volume from a remaining volume of the first chamber 14.

The elastic diaphragm 50 may be, for example, a polymer diaphragm. The elastic diaphragm 50 may likewise be formed from an elastomer. However, it is pointed out that the implementability of elastic diaphragm 50 is not limited to the materials listed here. Instead of the elastic diaphragm 50, porous and/or sponge-like structures, elastomers and/or spring systems may also be employed. In particular, plates for sealing off the first chamber 14/compression chamber may be used.

As can be seen from FIGS. 8b and 8c, the at least one liquid 16 can be reliably pumped out of the second chamber 18 into the third chamber 52 also by means of the embodiment of the turret component 10 described here. To increase the backforce of the elastic diaphragm 50, additional actuation units may be arranged on this. For example, the return of the elastic diaphragm 50 may be assisted by a magnetic, piezoelectric, electrostatic, electromagnetic, pneumatic and/or hydraulic actuator. For example, a spring trough may be arranged on the elastic diaphragm 50. Depending on the rating of the actuation force Fa, the return of the elastic diaphragm 50 can thus also take place when the actuation force Fa is comparatively high.

In a development, the elastic diaphragm 50 may also be designed such that it tears apart under a specific/fixable actuation force Fa and releases the at least one liquid 16 in this way, for example in order to conduct the latter into a further chamber and/or into a further turret. Moreover, the elastic diaphragm 50 may also be actively destructible, for example in that it can be arched to an extent such that it can be punctured in its arched state by means of a spike.

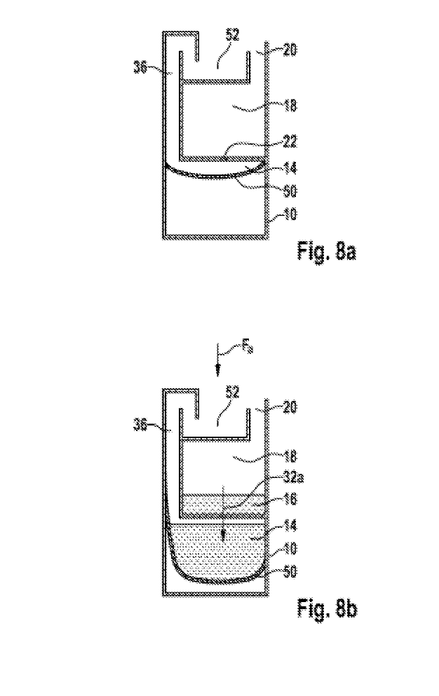

FIG. 9 shows a diagrammatic illustration of an embodiment of the reagent vessel insert part.

The reagent vessel insert part 54 illustrated diagrammatically in FIG. 9 has an insert part housing which is designed such that the reagent vessel insert part 54 can be inserted in a reagent vessel for a centrifuge and/or for a pressure variation device. The insertibility of the reagent vessel insert part 54 into the respective reagent vessel for a centrifuge and/or a pressure variation device may be interpreted such that an outer wall 58 of the insert part housing 56 matches with an inner wall of the reagent vessel. Preferably, the outer wall 58 of the insert part housing 56 contacts the inner wall of the reagent vessel in such a way that a reliable hold of the reagent vessel insert part 54 in the respective reagent vessel is ensured even while the centrifuge and/or the pressure variation device is in operation. As regards the reagent vessel into which the reagent vessel insert part 54 can be inserted, reference is made to the exemplary embodiments listed above. However, the reagent vessel cooperating with the reagent vessel insert part 54 is not limited to these.

Moreover, the reagent vessel insert part 54 comprises at least one turret component 10a, 10b and 10c arranged in the insert part housing 56. The at least one turret component 10a, 10b and 10c may be designed such that it can be rotated about the axis of rotation 11. Moreover, the at least one turret component 10a, 10b and 10c may also be adjustable (laterally) along the axis of rotation 11. A spacing between adjacent turret components 10a, 10b and 10c can thereby also be varied. As regards the further implementability of the at least one turret component 10a, 10b and 10c, reference is made to the above descriptions.

The lateral adjustability of the at least one turret component 10a, 10b and 10c can be brought about, for example, by means of a ballpoint pen mechanism 60 which is illustrated merely diagrammatically in FIG. 9.

(Components of the ballpoint pen mechanism 60 may be designed, for example, as an integral part of the first turret component 10 and/or of the second turret component 10b). Instead of the ballpoint pen mechanism 60, a deformable polymer/elastomer may also be utilized to provide a return force which causes the at least one turret component 10a, 10b and 10c to return to a stipulated initial setting/initial setting. A compressible material, such as, for example, a polymer, may also be used for this purpose. Instead of a compressible material, a stretchable material may also be employed, which generates a pull force which, as a return force, causes the at least one turret component 10a, 10b and 10c to be adjusted back into an initial setting/initial position.

The gas 26/gas volume used as a variable-expansion boundary may also be enclosed between two turrets 10a, 10b and 10c/turret components. During the actuation of the system, the gas 26 used as a variable-expansion boundary can be enclosed, in particular, between the respective turrets 10a, 10b and 10c. Relative rotation between the two turrets 10a, 10b and 10c can compress the gas 26. In this case, special gas capture structures may also be used, such as, for example, a depression in a fixed turret 10a, 10b and 10c, which depression is contacted by a pin of the rotatable/moveable turret 10a, 10b and 10c, the gas 26 arranged in the depression being compressed. Pneumatic/mechanical actuators can thus also be implemented. If the gas 26 is reserved and is not enclosed during actuation, it can be reserved under overpressure. This gives rise to a prestressed elastic element.

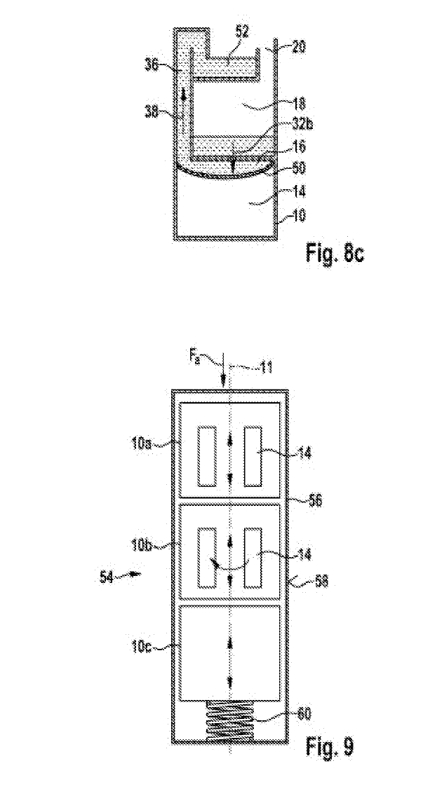

FIG. 10 shows a flow chart to explain an embodiment of the method for centrifuging a material.

In a method step S1, the material to be centrifuged is introduced into a reagent vessel having a turret component inserted therein. The turret component, which may also be incorporated after the introduction of the material into the reagent vessel, is equipped with the advantageous technology. In particular, the turret components described above can be used in order to carry out the method. However, the implementability of the method described here is not limited to the use of these turret components.

In a method step S2, a centrifuge is operated at a current rotational speed corresponding to a first desired rotational speed which gives rise to a first centrifugal force upon the material to be centrifuged and/or upon another liquid introduced into the reagent vessel, said first centrifugal force being higher than a backforce of the variable-expansion boundary (for the turret component). Thus, as described above, the variable-expansion boundary is reversibly deformed and/or compressed such that the material to be centrifuged and/or the other liquid are/is sucked at least partially into the first chamber.

Preferably, the method also comprises the method steps S2 and S3 which are in this case carried out at least once. In the method step S2, there is an intermediate reduction of the current rotational speed to a second desired rotational speed which gives rise to a second centrifugal force lower than the backforce of the reversibly deformed and/or compressed variable-expansion boundary, with the result that the material to be centrifuged, sucked into the first chamber, and/or the other liquid are/is pressed at least partially out of the first chamber. In the subsequent method step S3, the current rotational speed is increased to a third desired rotational speed which gives rise to a third centrifugal force higher than the backforce of the variable-expansion boundary.

In particular, a repeated execution of method steps S2 and S3 may be used for the mixing of a plurality of liquids and/or for the pumping of liquid counter to the centrifugal force.

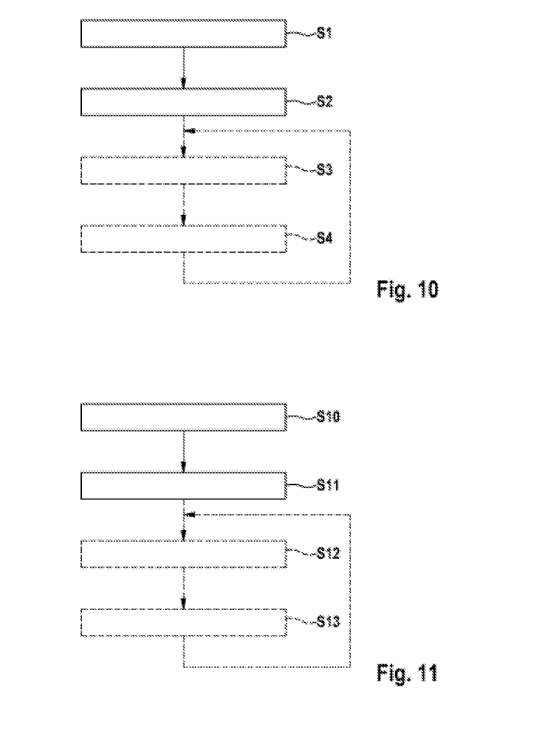

FIG. 11 shows a flow chart to explain an embodiment of the method for the pressure treatment of a material.

The material, for example a sample material, to be treated by means of an underpressure or overpressure, is introduced into a reagent vessel having a turret component inserted therein (method step S10). For example, the turret components described above can be used to carry out the method. However, the implementability of the method described here is not limited to the use of these turret components.

In a method step S11, an underpressure or overpressure corresponding to a first desired pressure is applied, which gives rise to a first pressure force upon the material and/or upon another liquid introduced into the reagent vessel, said first pressure force being higher than a backforce of the variable-expansion boundary. The varied-expansion boundary is thereby reversibly deformed and/or compressed such that the material to be centrifuged and/or the other liquid are/is sucked at least partially into the first chamber.

In an advantageous development, the method also has the method steps S12 and S13 which can be repeated as often as desired. In method step S12, the underpressure or overpressure is adjusted in the direction of atmospheric pressure to a second desired pressure which gives rise to a second pressure force lower than the backforce of the reversibly deformed and/or compressed variable-expansion boundary with the result that the material to be centrifuged, sucked into the first chamber, and/or the other liquid are/is pressed at least partially out of the first chamber. Subsequently, in method step S13, the underpressure or overpressure can be intensified away from atmospheric pressure to a third desired pressure which gives rise to a third pressure force higher than the backforce of the variable-expansion boundary. Method steps S12 and S13 can thereafter be repeated at least once.

The implementation of the method described here also ensures the advantages already listed above. There is no need here for a renewed description of these advantages.

1. A turret component for a reagent vessel, comprising:
at least one first chamber formed on the turret component, the at least one first chamber being configured to be at least partially filled with at least one liquid,
wherein the first chamber has a filling volume, fillable or filled with the at least one liquid, configured to be delimited by a variable-expansion boundary, the variable-expansion boundary having reversibly variable spatial expansion such that the filling volume is configured to be varied.

2. The turret component as claimed in claim 1, wherein the first chamber comprises one or more of an enclosed gas, an elastic filling, and an elastic diaphragm as the variable-expansion boundary.

3. The turret component as claimed in claim 1, further comprising a second chamber with a filling and/or pressure compensation orifice, the second chamber being connected to the first chamber via at least one first connecting structure having a first hydrodynamic resistance.

4. The turret component as claimed in claim 3, further comprising a second connecting structure formed on the first chamber, the second connecting structure having a second hydrodynamic resistance lower than the first hydrodynamic resistance and connecting the first chamber to the second chamber or a third chamber.

5. The turret component as claimed in claim 4, wherein the first chamber is configured to be air-tight, with the exception of the first connecting structure or with the exception of the first connecting structure and the second connecting structure, such that a gas is configured to be enclosed in the first chamber by an at least partial filling of the second chamber.

6. The turret component as claimed in claim 1, wherein the turret component has a turret outer wall configured such that the turret component is configured to be inserted in a reagent vessel for a centrifuge and/or for a pressure variation device.

7. The turret component as claimed in claim 1, wherein the turret component is insertable in an insert part housing of a reagent vessel insert part configured such that the reagent vessel insert part is configured to be inserted in a reagent vessel for a centrifuge and/or for a pressure variation device.

8. The turret component as claimed in claim 6, wherein the at least one liquid is capable of being sucked into the first chamber, counter to a backforce of the deformed and/or compressed variable-expansion boundary, by a centrifugal force configured to be brought about during operation of the centrifuge, in the rotor device of which is arranged the reagent vessel having the turret component inserted therein, and/or by a pressure force configured to be brought about during operation of the pressure variation device, in which the reagent vessel having the turret component inserted therein is arranged.

9. The turret component as claimed in claim 8, wherein the at least one liquid sucked into the first chamber by the centrifugal force and/or the pressure force is capable of being pressed out of the first chamber by the backforce insofar as the backforce of the deformed and/or compressed variable-expansion boundary is higher than the centrifugal force and/or the pressure force.

10. (canceled)

11. A reagent vessel insert part, comprising:
an insert part housing configured such that the reagent vessel insert part is configured to be inserted in a reagent vessel for a centrifuge and/or for a pressure variation device; and
at least one turret component arranged in the insert part housing, the at least one turret component including at least one first chamber formed in the insert part housing, the at least one first chamber being configured to be at least partially filled with at least one liquid,
wherein the first chamber has a filling volume, fillable or filled with the at least one liquid, configured to be delimited by a variable-expansion boundary, the variable-expansion boundary having a reversibly variable spatial expansion such that the filling volume is configured to be varied.

12. The turret component as claimed in claim 1, wherein the at least one turret component is arranged in a reagent vessel.

13. The turret component as claimed in claim 12, wherein the reagent vessel has an outer wall configured such that the reagent vessel is configured to be inserted in a centrifuge and/or in a pressure variation device.

14. A method for centrifuging and/or for the pressure treatment of a material, comprising:
introducing the material to be centrifuged and/or pressure treated into a reagent vessel having a turret component, the turret component having at least one first chamber formed on the turret component, the at least one first chamber being configured to be at least partially filled with at least one liquid and having a filling volume, fillable or filled with the at least one liquid, configured to be delimited by a variable-expansion boundary, the variable-expansion boundary having reversibly variable spatial expansion such that the filling volume is configured to be varied, the turret component being inserted, into a reagent vessel having a reagent vessel insert part which is inserted therein and/or into a reagent vessel; and
operating a centrifuge at a current rotational speed corresponding to a first desired rotational speed that gives rise to a first centrifugal force upon the material to be centrifuged and/or upon another liquid introduced into the reagent vessel, or applying an underpressure or overpressure corresponding to a first desired pressure that gives rise to a first pressure force upon the material and/or upon another liquid introduced into the reagent vessel, said first centrifugal force and/or said first pressure force being higher than a backforce of the variable-expansion boundary, with the result that the variable-expansion boundary is reversibly deformed and/or compressed such that the material to be centrifuged and/or pressure treated and/or the other liquid are/is sucked at least partially into the first chamber.

15. The method as claimed in claim 14, further comprising:
at least once-only reducing the current rotational speed to a second desired rotational speed that gives rise to a second centrifugal force lower than the backforce of the reversibly deformed and/or compressed variable-expansion boundary, or at least once-only adjusting the underpressure or overpressure in the direction of atmospheric pressure to a second desired pressure that gives rise to a second pressure force lower than the backforce of the reversibly deformed and/or compressed variable-expansion boundary, with the result that the material to be centrifuged and/or pressure treated, sucked into the first chamber, and/or the other liquid are/is pressed at least partially out of the first chamber, and
increasing the current rotational speed to a third desired rotational speed that gives rise to a third centrifugal force higher than the backforce of the variable-expansion boundary, or intensifying the underpressure or overpressure away from atmospheric pressure to a third desired pressure that gives rise to a third pressure force higher than the backforce of the variable-expansion boundary.

16. (canceled)

17. (canceled)
